(19) United States
(12) Patent Application Publication
(10) Pub. No.: US 2006/0280920 A1
(43) Pub. Date: Dec. 14, 2006

(54) Selective contact with a continuously moving ribbon of brittle material to dampen or reduce propagation or migration of vibrations along the ribbon

(76) Inventor: John Steele Abbott III, Elmira, NY (US)

Correspondence Address: CORNING INCORPORATED, SP-TI-3-1, CORNING, NY, 14831, US

(21) Appl. No.: 11/150,747

(22) Filed: Jun. 10, 2005

(51) Int. Cl. B32B 18/00; C03C 19/00; C03B 40/02; C03B 23/00

(52) U.S. Cl. 428/210; 65/23; 65/24; 65/28; 65/60.1

(57) ABSTRACT

Stabilization of a moving ribbon of brittle material is provided by non-degrading contact in a quality area of the ribbon or degrading contact in a non-quality area of the ribbon. The non-degrading contact can include a removable coating applied to the quality area, thereby protecting the underlying ribbon. The non-degrading contact can be provided by resilient brushes or rollers. The degrading contact can include the application of a stiffener to the ribbon or the intermittent contact with ribbon coinciding with a downstream score line formation or crack propagation.

### BACKGROUND OF THE INVENTION

1. Field of the Invention

The present invention relates to the manufacture of glass substrates, and more particularly, to the control of mechanical disturbances migrating from an elastic portion of a ribbon to a visco-elastic portion of the ribbon.

2. Description of Related Art

Specialized glasses have found increased applicability, including substrates, in the manufacture of display devices. For example, liquid crystal displays (LCDs) have become increasingly popular for displaying information in calculators, watches, video games, audio and video equipment, portable computers and even car dashboards. The improving quality and size of LCDs has made the LCDs an attractive alternative to cathode ray tubes (CRTs) which are traditionally used in television sets and desktop computer displays. In addition, other flat panel display (FPD) types, such as plasma displays (PDs), field emission displays (FEDs) and organic light-emitting polymer displays (OLEDs) are being developed as alternatives to LCDs. Thin film transistor liquid crystal displays (TFT-LCD) are used in notebook computers, flat panel desktop monitors, LCD televisions, and Internet and communication devices, to name only a few. It is increasingly useful to incorporate electronic components onto a glass sheet (glass substrate) used in the display device. Some display devices such as TFT-LCD panels and OLED panels are made directly on flat glass sheets. For example, the transistors are arranged in a patterned array and are driven by peripheral circuitry to provide (switch on) desired voltages to orient the molecules of the LC material in the desired manner.

As can be readily appreciated, any in-plane distortions or strain can result in a variation of the alignment of the transistors and the pixels. This can result in distortion in the display panel. As such, in LCD and other glass display applications, it is exceedingly beneficial to provide glass (substrates) that are within acceptable tolerances for flatness and resulting strain.

Flat panel display manufacturers are finding that demands for larger display sizes and the economies of scale are driving manufacturing processes to larger size pieces of glass. Industry standards have evolved from Gen III (550 mm×650 mm), Gen III.5 (600 mm×720 mm), and Gen IV (1,000 mm×1,000 mm) sizes and larger. As the desired size of the glass pieces increases, the difficulty of the production and handling increases.

The manufacturing of the glass used as the substrate is extremely complex. The drawdown sheet or fusion process, described in U.S. Pat. No. 3,338,696 (Dockerty) and U.S. Pat. No. 3,682,609 (Dockerty), herein incorporated by reference, is one of the few processes capable of delivering the glass without requiring costly post forming finishing operations such as lapping and polishing.

However, the fusion process requires the separation and removal of panes from a continuously moving ribbon of glass. Traditionally, the separation of the panes has been performed by forming a separation line in the ribbon of glass. A vacuum cup array is then attached to the glass below the score line and the portion of the ribbon below the score line is rotated to cause the glass to break at the score line and thus form the desired glass pane. This breaking produces a newly formed leading edge on the moving ribbon and a newly formed trailing edge on the glass pane.

However, this exertion of such a large bending moment on the ribbon, imparts significant potential energy to the ribbon, which is released upon the snapping of the pane from the ribbon. Introduction of this energy (and mechanical disturbance) into the ribbon can lead to undesirable characteristics in subsequent glass panes.

In addition, a variety of mechanical forces are typically exerted on the ribbon prior to separation of a pane, such as pulling rollers and score line formation contact. These contacts can induce undesirable disturbances to the ribbon.

Therefore, there is a need to reduce unintended shape altering forces in selected portions of the ribbon. The more specific need exists to reduce the migration of mechanical disturbances toward the visco-elastic portion of the ribbon.

### BRIEF SUMMARY OF THE INVENTION

The present invention provides for the selective contact with a continuously moving ribbon of brittle material to dampen or reduce propagation or migration of vibrations along the ribbon. In addition, the present invention can be configured to dampen or reduce movement or displacement of an upstream portion of the ribbon due to movement or displacement of a downstream portion of the ribbon. The movement or vibration of the ribbon that is reduced or dampened includes vibrations as well as displacements associated with ribbon processing such as scoring. In certain configurations, the contact with the ribbon can be a “quality area” of the ribbon or a “non-quality area” of the ribbon.

The present invention reduces the migration of unintended mechanical disturbances from an elastic portion of a ribbon of brittle material toward a visco-elastic portion of the ribbon. By stabilizing the ribbon, or predetermined locations of the ribbon, the resulting panes can have reduced in-plane stresses.

In selected configurations, the present system contacts one of a quality area or a non-quality area of an elastic portion of a continuously moving ribbon to reduce the transmission of disturbances into the upstream ribbon (or toward a visco-elastic portion of the ribbon). Further the configurations can reduce or dampen an upstream movement or displacement of the ribbon due to a downstream movement or displacement of the ribbon.

One configuration contemplates the application of a removable coating to a quality area of the ribbon intermediate a terminal end of the ribbon and the visco-elastic portion of the ribbon. The removable coating can be selected to allow contact in the quality area, through the removable coating, while reducing damage to the underlying surface of the ribbon.

A further configuration contemplates a non-degrading contact in a quality area of the ribbon, wherein rollers or brushes contact with ribbon without marring or scratching the surface of the ribbon.

Alternative configurations also include a degrading contact, such as by clamping or adding stiffeners in non-quality areas of the ribbon upstream of a score line, or separation line.

Additional features and advantages of the invention are set forth in the detailed description which follows, and in part will be readily apparent to those skilled in the art from that description or recognized by practicing the invention as described herein. For purposes of description, the following discussion is set forth in terms of glass manufacturing. However, it is understood the invention as defined and set forth in the appended claims is not so limited, except for those claims which specify the brittle material is glass.

It is to be understood that both the foregoing general description and the following detailed description are merely exemplary of the invention, and are intended to provide an overview or framework for understanding the nature and character of the invention as claimed below. Also, the above listed aspects of the invention, as well as the preferred and other embodiments of the invention discussed and claimed below, can be used separately or in any and all combinations.

The accompanying drawings are included to provide a further understanding of the invention and are incorporated in and constitute a part of this specification. The drawings illustrate various embodiments of the invention, and together with the description, serve to explain the principles and operation of the invention. It should be noted that the various features illustrated in the figures are not necessarily drawn to scale. In fact, the dimensions may be arbitrarily increased or decreased for clarity of discussion.

### BRIEF DESCRIPTION OF THE SEVERAL VIEWS OF THE DRAWINGS

FIG. 1 is a schematic of a representative apparatus for forming a ribbon of brittle material.

FIG. 2 is a front elevational schematic of a ribbon of brittle material.

FIG. 3 is an elevational schematic of a removable coating on a portion of the ribbon.

FIG. 4 is an elevational schematic of an alternative configuration of the removable coating on a portion of the ribbon.

FIG. 5 is a side elevational schematic of a damping roller contacting the removable coating.

FIG. 6a is a side elevational schematic of the application of the removable coating to the ribbon.

FIG. 6b is a side elevational schematic of an alternative application of the removable coating to the ribbon.

FIG. 6c is a side elevational schematic of a further application of the removable coating to the ribbon.

FIG. 7 is a cross sectional schematic of an adhesive retaining the removable coating relative to the ribbon.

FIG. 8 is a side elevational schematic of a plurality of brush configurations contacting a quality area of the ribbon.

FIG. 9 is front elevational schematic of a roller contacting the ribbon along a quality area

FIG. 10 is a side elevational schematic of alternative configurations of a roller assembly contacting a quality area of the ribbon.

FIG. 11 is a cross sectional schematic of a roller for contacting a quality area of the ribbon.

FIG. 12 is a cross sectional schematic of an alternative roller for contacting a quality area of the ribbon.

FIG. 13 is a front elevational schematic of a stiffener on a non-quality area of the ribbon.

FIG. 14 is a side elevational schematic of a stiffener bonded to the ribbon upstream of the score line.

FIG. 15 is a front elevational schematic of a clamping jaw engaging a non-quality area of the ribbon proximal to an intended location of a future score line.

FIG. 16 is a cross sectional schematic of the clamping jaw engaging the ribbon.

### DETAILED DESCRIPTION OF THE INVENTION

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention can be practiced in other embodiments that depart from the specific details disclosed herein. Moreover, descriptions of well-known devices, methods and materials may be omitted so as not to obscure the description of the present invention.

For purposes of description, the present invention is set forth as separating glass panes from a moving ribbon of glass.

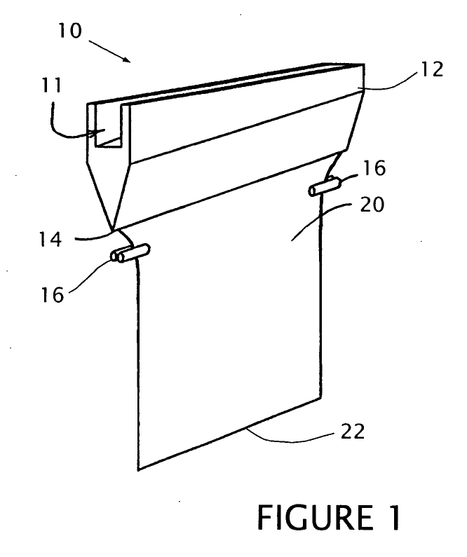

FIG. 1 is a schematic of glass fabrication apparatus 10 of the type typically used in the fusion process. The apparatus 10 includes a forming isopipe 12, which receives molten glass (not shown) in a cavity 11. The molten glass flows over the upper edges of the cavity 11 and descends along the outer sides of the isopipe 12 to a root 14 to form the ribbon of glass 20. The ribbon of glass 20, after leaving the root 14, traverses fixed edge rollers 16. The ribbon 20 of brittle material is thus formed and has a length extending from the root 14 to a terminal free end 22. As the glass ribbon 20 travels down from the isopipe 12, the ribbon changes from a supple 50 millimeter thick liquid form at, for example, the root 14 to a stiff glass ribbon of approximately 0.03 mm to 2.0 mm thickness at the terminal end 22.

Such draw down sheet or fusion processes, are described in U.S. Pat. No. 3,338,696 (Dockerty) and U.S. Pat. No. 3,682,609 (Dockerty), and are herein incorporated by reference. The details are omitted so as to not obscure the description of the example embodiments. It is noted, however, that other types of glass fabrication apparatus can be used in conjunction with the invention. For those skilled in the art of glass forming, it is known that there are multiple methods to achieve such a structure, such as laminated down draw, slot draw and laminated fusion processes.

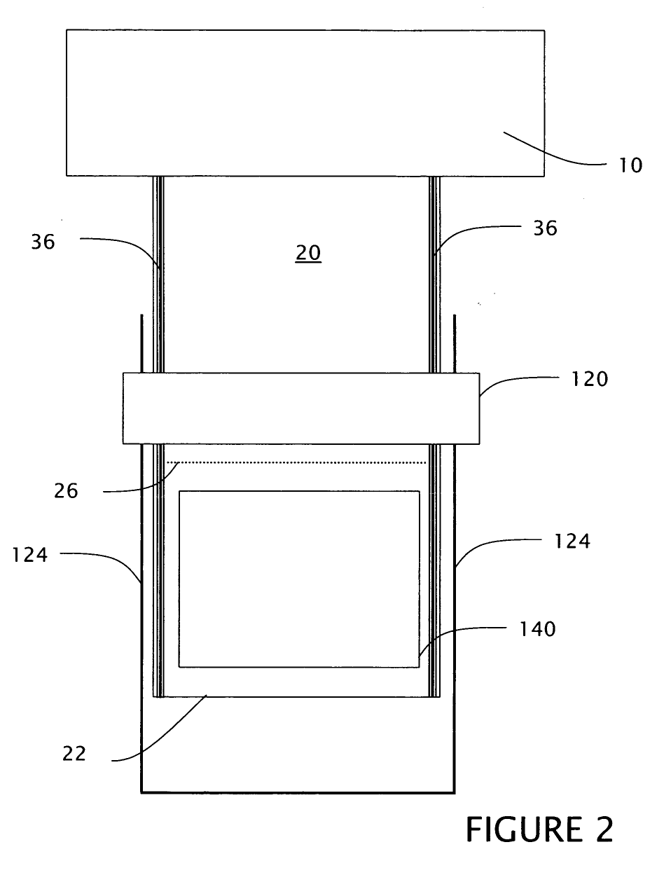

For purposes of definition, as the ribbon 20 descends from the root 14, the ribbon travels at a velocity vector V describing movement of the ribbon and forms a generally flat configuration having a generally planar first side 32 and a generally planar second side 34. In certain configurations, the ribbon 20 includes lateral beads or bulbous portions 36 (shown in FIG. 2) which are sized for engagement by the fixed rollers 16 or control surfaces during travel of the ribbon from the isopipe 12. With respect to the ribbon 20, the terms “opposed” or “opposing” mean the contact on both the first side 32 and the second side 34 of the ribbon.

Depending upon the stage or operation within the sequence, the term “upstream” means between one of the intended location of a score line 26 or the location of the score line and the root 14. The term “downstream” means between one of the intended location of the score line 26 or the location of the score line and the terminal end 22 of the ribbon 20. Other uses of the terms upstream and downstream shall refer to the specific location of interest, and mean toward the root 14 or toward the terminal end 22 of the ribbon 20, respectively.

The separation of a pane 24 from the ribbon 20 occurs within a given distance range from the root 14. That is, under constant operating parameters, the glass ribbon 20 reaches a generally predetermined solid state at a generally constant distance from the root 14, and is thus amenable to separation. The separation of the pane 24 from the ribbon 20 occurs along the score line 26 formed in at least one side of the ribbon.

As seen in FIG. 2, a carriage 120 can travel along a rail 124 to travel with the ribbon. The carriage 120 can carry a scoring assembly and separating assembly 100 for forming the score line 26 and propagating a crack along the score line to separate the pane 24 from the ribbon.

The term “quality area” QA encompasses that portion of the ribbon 20 which forms a subsequent optical element or functions as a glass substrate. The term “non-quality area” NQA encompasses that portion of the ribbon 20 that is either discarded or is not required to meet subsequent tolerances in a resulting product or application. The term “non-degrading contact” means a contact which does not preclude the resulting pane 24 from performing an intended function, without requiring secondary operations to remedy the results of the contact. Conversely, the term “degrading contact” is such contact that mars, scratches or distorts the ribbon 20 to an extent which would preclude a resulting pane 24 from performing an intended function unless secondary corrective procedures such as polishing or grinding are employed.

Contrary to traditional teachings, one configuration of the present invention contemplates the direct contact with a quality area of the ribbon 20 prior to separation of the pane 24 from the ribbon. This contact with the quality area of the ribbon 20 is downstream of the visco-elastic portion of the ribbon and upstream of the score line 26 for separating the pane 24 from the ribbon.

Quality Area Contact

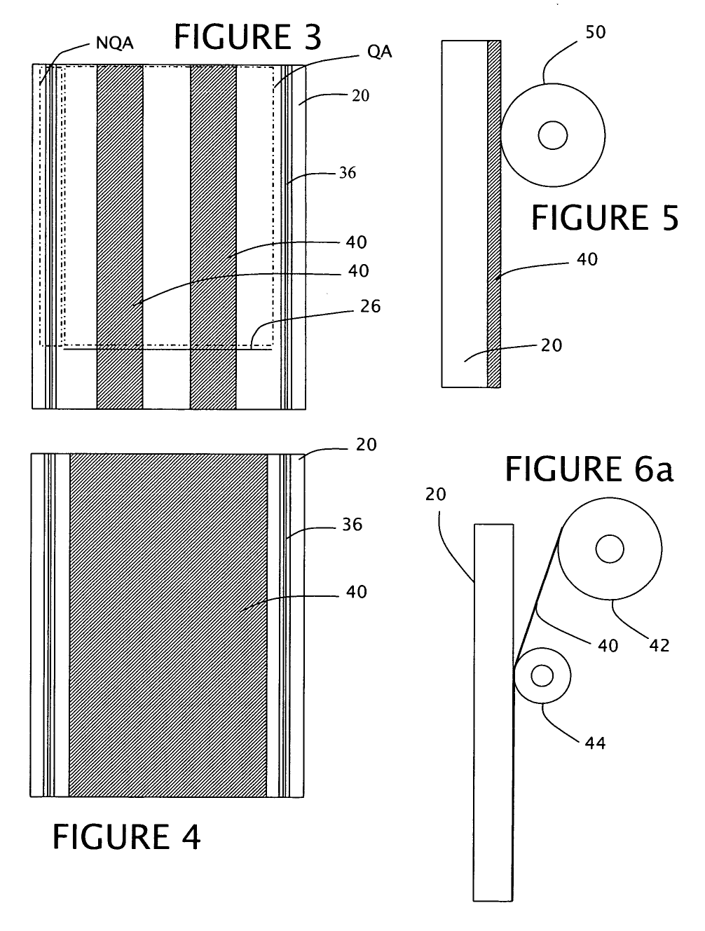

In a first example of this configuration, as seen in FIGS. 3-5, a removable coating 40 is applied to the ribbon 20 downstream of the transformation zone. The removable coating 40 is selected to provide for contact with the coated portion of the ribbon 20 with damping rollers or surface 50, schematically shown in FIG. 5, without degrading the underlying surface of the ribbon. For example, the removable coating 40 can overlie the ribbon 20 upstream of the score line 26 intermediate the beads 36, so that damping rollers or surfaces 50 can contact the ribbon to reduce the migration of vibrations or disturbances along the ribbon. Referring to FIG. 3, the removable coating 40 can form an elongate strip extending along the longitudinal dimension of the ribbon 20. Alternatively, as shown in FIG. 4, the removable coating 40 can extend substantially across the entire width of the ribbon 20 intermediate the beads 36. The damping rollers or surfaces 50 can be rollers as currently employed in the fabrication of glass panes 24. Alternatively, the damping rollers or surfaces 50 can be as set forth below, wherein the surfaces non-degradingly contact the ribbon 20.

Although the removable coating 40 can be applied to and removed from the ribbon 20 upstream of the score line 26, it is contemplated, the introduction of disturbances related to the removal of the coating can be reduced by removing the coating from the pane 24 after separation of the pane from the ribbon.

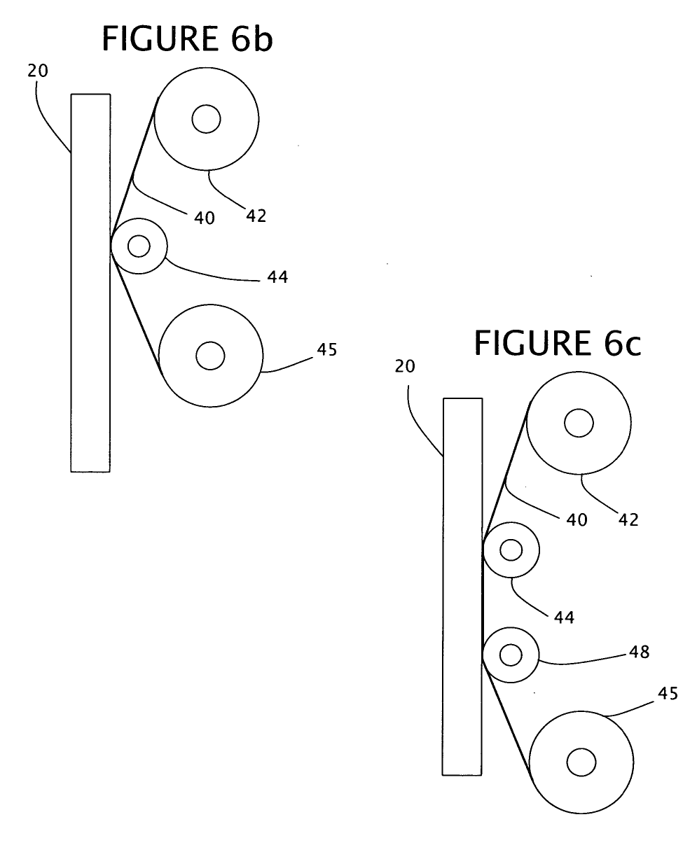

As seen in FIGS. 6a, 6b, and 6c, the removable coating 40 can be a preformed film, such as a polymer film that can be adhered or bonded to the ribbon 20. Alternatively, the removable coating 40 can be applied as a spray, mist or dusting. That is, the removable coating 40 is formed by impacting sufficient particles against the ribbon 20 to form the protective removable coating.

In one configuration, the removable coating 40 has a thickness to allow non-degrading contact with the ribbon 20. That is, the removable coating 40 prevents the underlying area of the ribbon 20 from being degraded upon contact on the coating. For example, contact which would otherwise scratch or mar the surface of the ribbon 20 occurs against the removable coating 40, thereby protecting the underlying ribbon.

In a further configuration, the removable coating 40 has a sufficient thickness or rigidity to distribute any contacting force on the exposed surface of the removable coating over a sufficiently large area such that the resulting pressure (force) on the underlying ribbon 20 is non-degrading.

The removable coating 40 is selected to avoid permanent heat bonding or melt bonding to the underlying ribbon 20. The ribbon 20 can have a temperature ranging from approximately 200° F. proximal to the terminal end 22 to approximately 800° F. proximal to the isopipe 12. It is contemplated the removable coating 40 may be applied in the area of the ribbon 20 that can have a temperature from approximately 300° F. to approximately 600° F. A satisfactory removable coating 40 is believed to include a cellophane or a polyester film, such as MYLAR®, a polyester film originally marketed by E.I. Dupont, or an alternative polymer composition selected to preclude permanent thermal bonding to the ribbon. It is advantageous for the removable coating 40 to avoid creating a thermal gradient in the underlying portion of the ribbon 20. That is, the removable coating 40 can be selected, either in material characteristics or physical thickness to minimize imparting thermal gradients in the ribbon 20.

As seen in FIGS. 6a, 6b, and 6c, the removable coating 40, as a preformed film, can be applied from a supply roll 42. An applicator roller 44 can be located to contact the removable coating 40 with the ribbon 20 to retain the removable coating relative to the ribbon. It is advantageous for the removable coating 40 to be at a temperature substantially equal to the temperature of the ribbon 20 to which the coating is applied. Further, heating of the applicator roller 44 to substantially the local temperature of the ribbon 20 reduces the creation of undesirable thermal gradients in the ribbon.

Referring to FIG. 6b, the removable coating 40 can be removed from the ribbon 20 to a take up reel 45 immediately downstream of the applicator roller 44. Thus, the applicator roller 44 functions to reduce or dampen movement or displacement of the ribbon 20, through the coating 40, wherein the coating is then immediately removed from the ribbon to the take up reel 45. The removable coating 40 thereby forms a pristine barrier between the ribbon 20 and the roller. Thus, the removable coating 40 can be a belt passing about the supply roll 42, the applicator roller 44, and the take up reel 45. Alternatively, as shown in FIG. 6a, the removable coating 40 remains with the ribbon 20. As seen in FIG. 6b, an additional roller 48 can be located downstream of the applicator roller 44 to reduce or dampen ribbon movement or displacement. Further, although the removable coating 40 and associated roller are shown as contacting a single side of the ribbon 20, it is understood the removable coating can be applied to both sides of the ribbon, wherein the removable coating is applied at the same longitudinal position on the ribbon or different longitudinal positions on the ribbon.

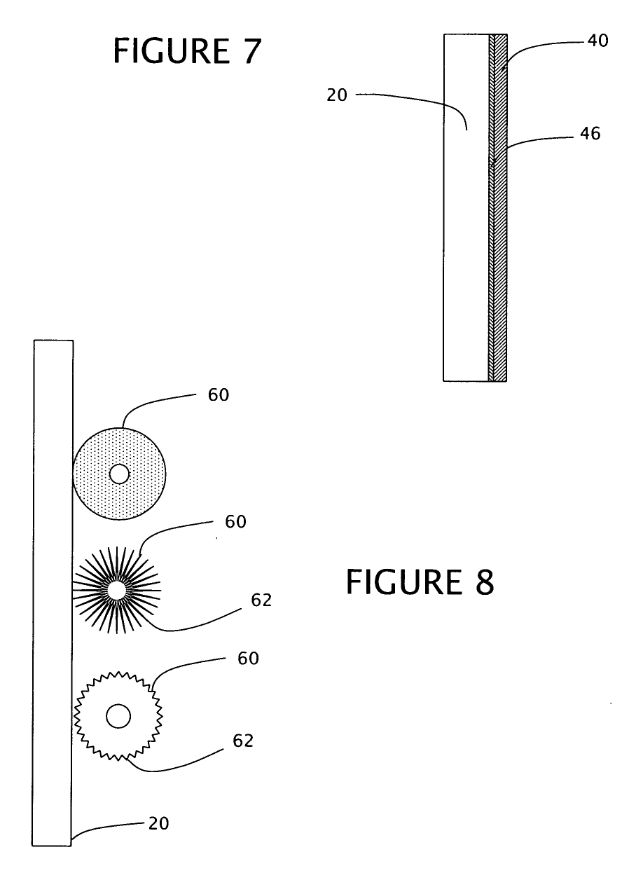

In a further configuration shown in FIG. 7, it is contemplated an adhesive 46 can be applied to the ribbon 20 and the removable coating 40 subsequently applied to the adhesive. Alternatively, the adhesive 46 can be applied to the ribbon 20, and the coating then applied to the adhesive.

Removal of the coating 40 (and adhesive 46 if employed), can occur after separation of the pane 24 from the ribbon 20. Depending upon the particular material of the removable coating 40, the coating (and/or adhesive 46 if employed) can be mechanically removed or separated from the pane 24 by blades or peeled, or dissolved by washes, or baths including but not limited to chemical sprays.

Therefore, the removable coating 40 can extend over substantially the entire area of the pane 24. However, as set forth, the removable coating 40 can cover less than ⅔, to less than ½ or even less than ¼ the area of the pane 24. That is, the removable coating 40 may not overlay the entire pane 24, but rather only selected portions or areas of the pane.

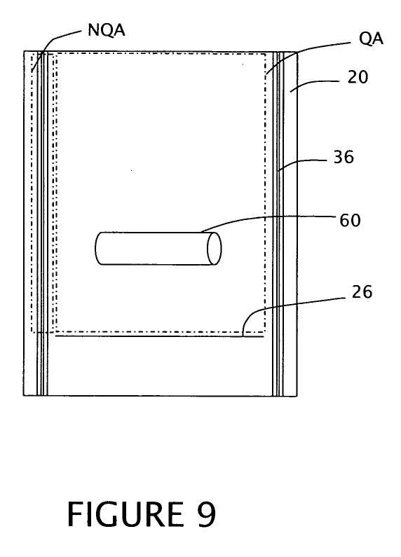

An alternative configuration of contacting the ribbon 20 in a quality area QA of the ribbon, prior to separation of the pane 24 from the ribbon, encompasses contact with the ribbon by a brush 60 as schematically seen in FIGS. 8 and 9.

While it is contemplated the brush 60 is temperature controlled, or regulated, to avoid imparting a temperature gradient to the local region of the ribbon 20, it is understood such brush can be the ambient temperature of the local environment of the ribbon. Typically, the brush 60 is heated to at least approximately 70° C. and advantageously to within approximately 50° C. of the local or contacted portion of the ribbon 20.

The brush 60 can have any of a variety of configurations such as feathery, cellular (open, closed cell or reticulated) or thin lightweight strips of high-temperature plastic wound into open coils. The material of the brush 60 is selected to avoid melting upon contact with the ribbon 20. As seen in FIG. 8, a number of representative shapes of the brush 60 are shown. The brush 60 can include feathery or compliant projections 62 which contact the ribbon 20, such that the temporary deformation of the projection absorbs energy from the ribbon, thereby damping movement of the ribbon transverse to the longitudinal ribbon movement.

By selecting the number, size and profile of the projections 62 and the intended contact force between the brush 60 and the ribbon 20, the amount of damping can be generally controlled.

In one configuration, the contact area of the brush 60 and the intended force between the brush and the ribbon 20 are selected to substantially ensure that contact between the brush and the ribbon is a non-degrading contact. Thus, the contact can occur in an uncoated quality area QA of the ribbon 20.

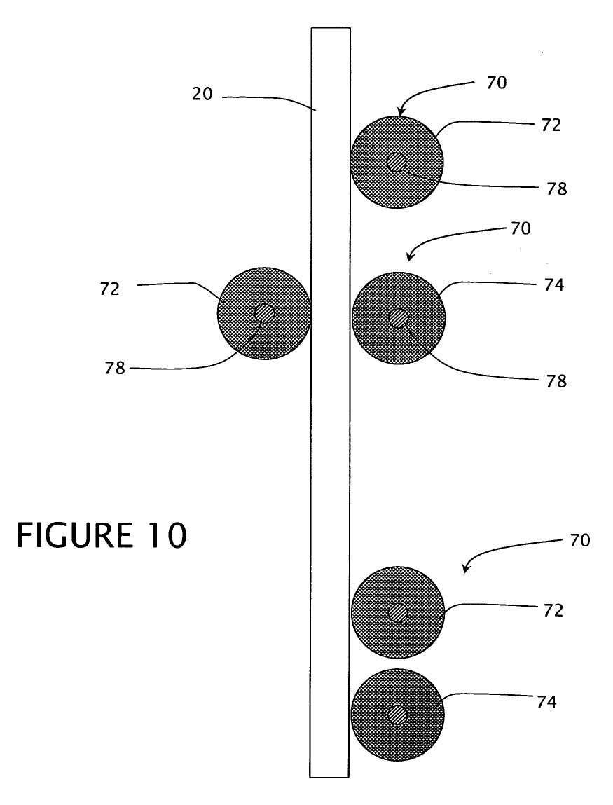

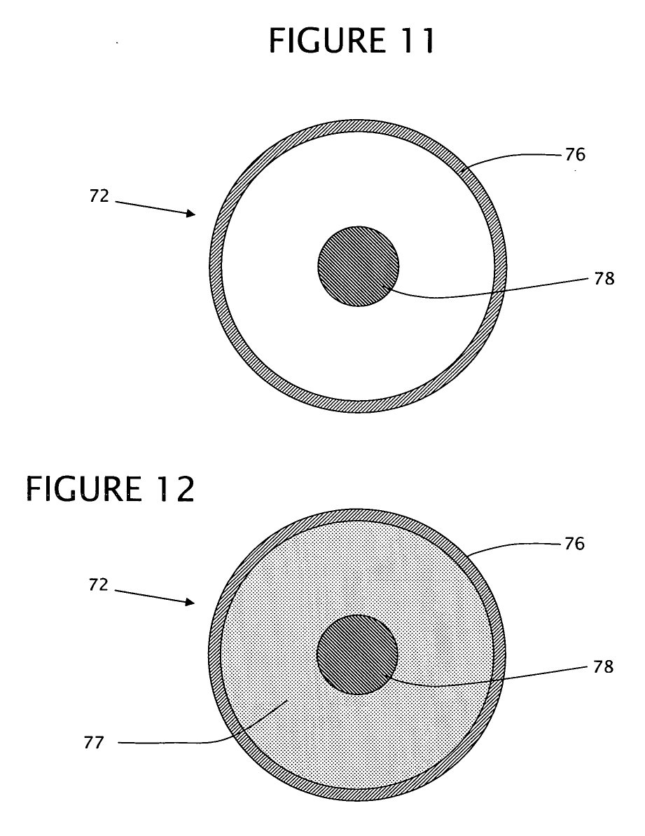

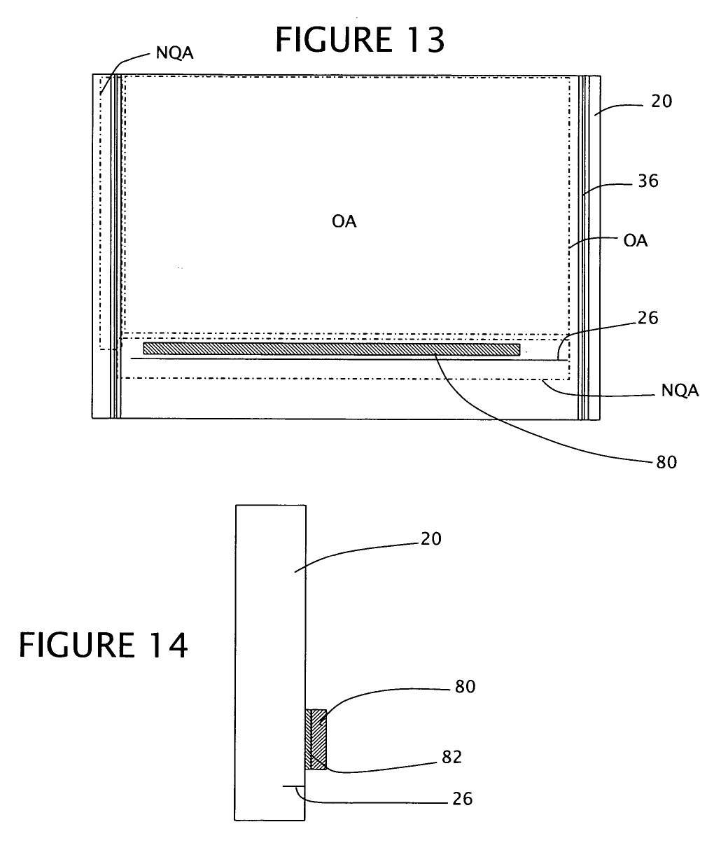

In a further configuration of non-degrading contact in a quality area of the ribbon, a roller assembly 70 contacts the ribbon, as seen in FIG. 10. The roller assembly 70 can be a single roller contacting one side of the ribbon 20. Alternatively, the roller assembly can include a pair of spaced apart rollers 72, 74 contacting a single side of the ribbon or defining a nip therebetween, wherein rolling contact is made on opposing sides of the ribbon 20, by passing at least a portion of the ribbon through the nip.

Referring to FIGS. 1 and 12, the rollers 72, 74 used in the roller assembly 70 can include a relatively thin drum 76 of flexible material connected to a shaft 78, thereby defining a substantially hollow interior. A temperature controlling medium can be disposed in the hollow interior for regulating a surface temperature of the rollers 72, 74.

The drum 76 is of a material which is typically softer than the ribbon 20, and does not adhere to the ribbon. In addition, due to the typical elevated manufacturing temperatures, the drum 76 is tolerant of the manufacturing temperatures.

In one configuration, the drum 76 defines a relatively thin wall which is pliable upon being biased against the ribbon 20. Thus, contact with the ribbon 20 dampens vibratory or torsional motion of the ribbon, without imparting significant force on the ribbon. That is, the compliant drum 76 absorbs energy from the ribbon 20.

In a further configuration, the drum 76 is a relatively rigid material, wherein a resilient or compliant core 77 interconnects the drum to the shaft 78. The compressible interconnection between the drum 76 and the shaft 78 allows an offset or eccentricity of the drum relative to the shaft under loading, thereby regulating the contact between the ribbon 20 and the drum. The resilient core 77 can thereby facilitate the damping of the vibratory ribbon movement.

The resilient elastic (offsetting) interconnection configuration, allows the drum 76 to be disposed at varying distances from the shaft 78, depending upon the radial loading of the rollers 72, 74. Therefore, while the distance between the shaft 78 of the two spaced rollers 72, 74 can be at a fixed distance, the distance between the contact surface of the respective drum 76 can vary in response to a loading force. Thus, the resilient, elastic interconnection between the drum 76 and the shaft 78 allows the spacing of the drum to vary, without requiring movement of the corresponding shaft 78.

In this construction, the compliant or resilient core 77 is disposed about the shaft 78 to be intermediate the shaft and the inner surface of the drum 76. The resilient, elastic compliant core 77 is selected to be nominally disposed in a concentric configuration with the shaft 78 and permit eccentric disposition of the shaft relative to the drum 76.

The resilient, elastic compliant core 77 can be formed from any of a variety of materials that provide sufficient resiliency for the drum 76 to move between the concentric position and the eccentric position with respect to the shaft 78. Suitable materials for the compliant core include spring metal, thermoplastics, thermosets, composites and alloys. Further, referring to FIG. 12, the material of the compliant core 77 can be a sponge or cellular (open or closed) or reticulated formation. As at least partially determined by the specific construction and materials, the compliant core 77 can have any of a variety of configurations including a solid material, flexible spokes, varying density resilient material, or cellular or foam construction. It is understood foamed or expanded polymeric materials and compositions, include, but are not limited to thermoplastic and thermoset materials as well as combinations thereof.

The roller assembly 70 is selected to urge or dispose the portion of the ribbon 20 in contact with the roller assembly in a predetermined configuration.

Replacement of the brush 60 or rollers 72, 74 is provided at sufficient intervals to preclude dust or glass particles from becoming embedded into the brush and resulting in the contact with the ribbon 20 being a degrading contact. Non-quality area contact

In one configuration, degrading contact can be made in a non-quality area of the ribbon 20. Such degrading contact can include coupling a stiffener 80 to the ribbon 20, or upstream contact of a clamping jaw 90 with the ribbon in a non-quality area This contact not only dampens movement of the ribbon 20 (such as minimizing transient effects), but also reduces upstream displacement of the ribbon (such as by minimizing the displacement of the upstream ribbon upon downstream displacement of the ribbon).

In a first aspect of this configuration, the stiffener 80 is attached to the ribbon 20 and extends generally transverse to the direction of ribbon travel. The stiffener 80 can be located adjacent or proximal to the score line 26 in the non-quality area of the ribbon 20. The stiffener 80 can be selected to either resist deformation or flexing of the ribbon 20, or dispose the local region of the ribbon in a generally predetermined configuration.

For example, the stiffener 80 can impart a substantially planar configuration to the local region of the ribbon 20, such as proximal to the score line 26. Alternatively, the stiffener 80 resists deformation without imparting a fixed profile to the ribbon 20, to thereby dampen vibrations in the ribbon, such as those induced during separation of the pane 24 from the ribbon.

The stiffener 80 can extend substantially transverse to the direction of ribbon travel, or can extend generally parallel to the travel of the ribbon, such as parallel to the lateral beads 36, in a non-quality area of the ribbon.

The stiffener 80 can be a self supporting member such as thin strip of metal or high temperature plastic. The stiffener 80 can be heat bonded to the ribbon 20. Alternatively, as seen in FIG. 14, an adhesive 82 can be disposed between the stiffener 80 and the ribbon 20 to operably retain the stiffener relative to the ribbon. As the stiffener 80 is located in a non-quality area NQA of the ribbon 20, it is contemplated the stiffener can remain bonded to the ribbon before, during and after separation of the pane 24 from the ribbon 20.

In an alternative version of the stiffener 80, the stiffener is a web with an adhesive for bonding to the ribbon 20, such as a duct tape-like web, wherein the material of the web and the adhesive are selected to withstand the anticipated local temperature of the ribbon. In this configuration, the stiffener 80 primarily acts to dampen movement of the ribbon 20.

Although the stiffener 80 is typically a single or one time use component, it is understood the stiffener can be recycled from the brittle material after separation from the ribbon 20.

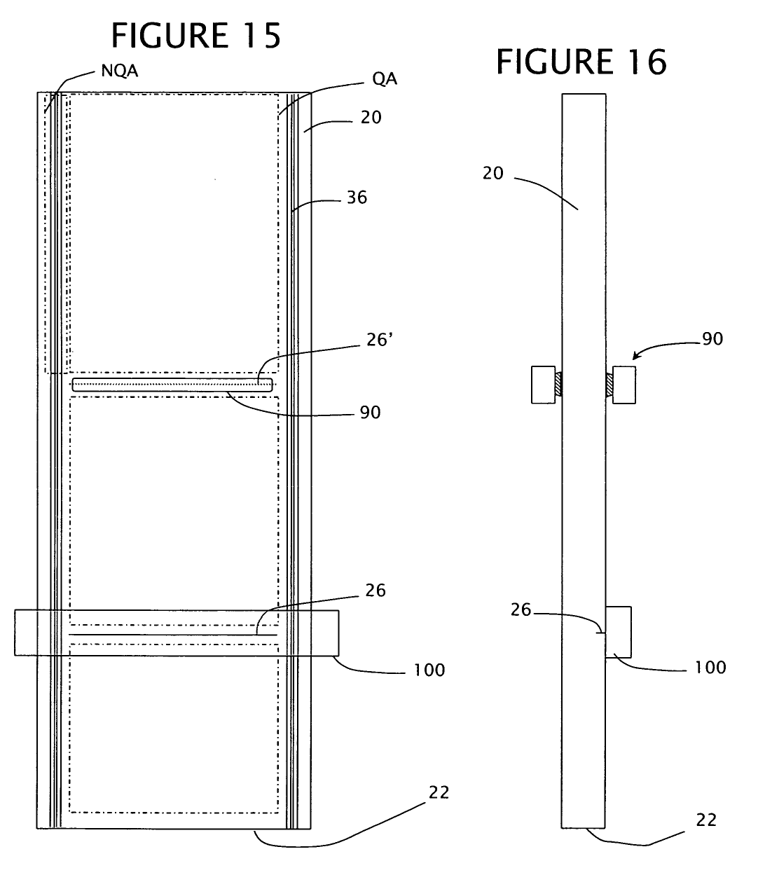

In a second aspect of this configuration seen in FIGS. 15 and 16, degrading contact occurs as a stabilizing contact by an intermittent contact with the ribbon 20 upstream of the score line 26, and particularly along, or proximal to, the intended location of a subsequent, yet to be formed, score line 26. It is contemplated such intermittent contact would typically occur at the location of the immediately subsequent score line 26, thereby occurring in a non-quality area NQA of the ribbon 20. This contact is a damping or stabilizing contact with the ribbon 20, and is typically coincident with the separation of the pane 24 from the ribbon 20. That is, the stabilizing contact is intermittent, rather than a continuous contact with the ribbon 20, upstream of the score line 26 and is generally spaced from the score line by the dimension of the pane 24.

Thus, while a scoring assembly and separating assembly 100 travel with the ribbon 20 at a distance from the terminal end 22 generally equal to the size of a pane 24 (to separate the pane from the ribbon), the degrading stabilizing contact occurs further upstream on the ribbon by a distance of the size of the pane.

The stabilizing contact is accomplished by opposing bars or a clamping jaw 90 that engage the ribbon 20 to effectively isolate the downstream ribbon from the upstream ribbon. As the stabilizing contact is along the intended area of a subsequent score line 26 (and separation of the pane 24 from the ribbon 20), the contact can be degrading. As the degradingly contacted portion of the ribbon 20 is intended to be discarded, a sufficient clamping force and fixing of the ribbon 20 can be applied without decreasing efficiency of the manufacturing process.

The clamping jaw 90 can be configured to provide a predetermined profile to the local region of the ribbon 20. The predetermined profile can be substantially flat, or configured, such as curvilinear, in conjunction with other manufacturing parameters.

As seen in FIG. 16, the clamping jaw 90 can be formed of a substantially rigid beam 92, such as steel or aluminum. The clamping jaw 90 can include a contacting surface 94 formed of a polymeric material connected to the beam 92 to assist in damping ribbon movement. That is, the contacting surface can be sufficiently compliant to absorb vibrations from the ribbon 20.

It is contemplated the clamping jaw 90 is connected to the carriage 120 for movement with the ribbon 20. Thus, in operation, the clamping jaw 90 engages the ribbon 20 upstream of the intended location of the yet to be formed score line 26. The score line 26 is then formed in the ribbon 20 (approximately the distance of a pane in the clamping jaw). Thus, the contact of the clamping jaw 90 is spaced from the score line 26 (and separation line) by a quality area of the ribbon. The pane 24 is then separated from the ribbon 20 along the formed score line 26, as the clamping jaw 90 is engaging the ribbon upstream to generally isolate the ribbon upstream of the clamping jaw from the ribbon downstream of the clamping jaw. The clamping jaw 90 thus reduces or dampens the transmission of vibrations associated with the formation of the score line 26 and separation of the pane 24 from the ribbon 20. The clamping jaw 90 is then removed and travels up the ribbon 20 to repeat the process.

A further advantage of the degrading contact in the non-quality areas of the ribbon 20 may result from inhibiting unintended crack propagation along the ribbon. That is, the degrading contact may be sufficient to arrest crack propagation that is not consistent with the score line 26.

While the invention has been described in conjunction with specific exemplary embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

What is claimed is:

1. A ribbon of brittle material having a visco-elastic portion and an elastic portion, at least a section of the ribbon having a removable coating.

2. The ribbon of claim 1, wherein the removable coating is on the elastic portion.

3. The ribbon of claim 1, wherein the removable coating is a separate sheet.

4. The ribbon of claim 1, wherein the brittle material is a glass.

5. The ribbon of claim 1, wherein the removable coating is one of sprayed and painted on the section of the glass ribbon.

6. The ribbon of claim 1, wherein the ribbon is continuous.

7. A method of stabilizing a continuous ribbon of brittle material, the ribbon having a visco-elastic portion and an elastic portion, the method comprising:
(a) applying a removable coating to the elastic portion of the ribbon; and
(b) contacting the removable coating to at least partially stabilize the ribbon.

8. The method of claim 7, further comprising removing the removable coating from the ribbon.

9. The method of claim 7, further comprising forming the removable coating as a film.

10. A method of stabilizing a moving ribbon of brittle material, the ribbon having a visco-elastic portion and an elastic portion, the method comprising:
(a) non-degradingly contacting a quality area in the elastic portion of the moving ribbon to dampen a disturbance propagating in the ribbon.

11. The method of claim 10, wherein non-degradingly contacting the ribbon includes contacting a brush with the moving ribbon.

12. The method of claim 10, further comprising employing a brush softer than the contacted portion of the ribbon.

13. The method of claim 10, further comprising heating the brush to within 50° C. of the temperature of the contacted portion of the ribbon.

14. The method of claim 10, further comprising heating the brush to at least 70° C.

15. The method of claim 10, wherein non-degradingly contacting includes applying a removable coating to the quality area.

16. The method of claim 10, wherein non-degradingly contacting includes contacting a roller with the quality area.

17. The method of claim 16, further comprising employing a roller softer than the portion of the contacted portion of the ribbon.

18. The method of claim 16, further comprising heating the roller to within 50° C. degrees of the temperature of the contacted portion of the ribbon.

19. The method of claim 16, further comprising heating the roller to at least 70° C.

20. A method of stabilizing a moving ribbon of brittle material, the ribbon having a visco-elastic portion and an elastic portion, the method comprising:
(a) applying a stiffener to the elastic portion of the ribbon.
